(19) United States
(12) Patent Application Publication
(10) Pub. No.: US 2017/0223323 A1
(43) Pub. Date: Aug. 3, 2017

(54) INPUT/OUTPUT DEVICE, INPUT/OUTPUT METHOD, AND COMPUTER-READABLE RECORDING MEDIUM

(71) Applicant: FUJITSU LIMITED, Kawasaki-shi (JP)

(72) Inventor: Hiroyuki MAEKAWA, Kawasaki (JP)

(73) Assignee: FUJITSU LIMITED, Kawasaki-shi (JP)

(21) Appl. No.: 15/491,892

(22) Filed: Apr. 19, 2017

Related U.S. Application Data
(63) Continuation of application No. PCT/JP2014/078268, filed on Oct. 23, 2014.

(51) Int. Cl. H04N 9/31; G06F 3/042

(52) U.S. Cl. CPC H04N 9/3194; H04N 9/3155; G06F 3/0425

(57) ABSTRACT

An input/output device includes a projection unit that projects projected images on a projection surface and an imaging unit that captures the projection surface. In switching an execution between the projection unit and the imaging unit, in a case where an indicator is included in captured images captured by the imaging unit, the input/output device suppresses projection of the projected images by the projection unit and prioritizes imaging by the imaging unit. In switching an execution between the projection unit and the imaging unit, in a case where an indicator is not included in captured images captured by the imaging unit, the input/output device suppresses imaging by the imaging unit and executes projection by the projection unit.

### CROSS-REFERENCE TO RELATED APPLICATION

This application is a continuation application of International Application PCT/JP2014/078268, filed on Oct. 23, 2014, and designating the U.S., the entire contents of which are incorporated herein by reference.

### FIELD

The embodiments discussed herein are related to an input/output device, an input/output method, and a non-transitory computer-readable recording medium.

### BACKGROUND

Known in the related art is a system for operating a projected image projected by a projector by an indicator such as a hand and a finger. Specifically, this system detects a position of a hand by capturing the projected image projected by the projector by two cameras, calculates a distance to the hand by using disparity of the two cameras, and detects a tapping operation of the hand on the projected image. In this way, the system realizes a function of combining a monitor and a touch panel on the projected image projected by the projector.

Display of the image projected by the projector on the hand deteriorates accuracy in hand recognition by the cameras. Therefore, output of the projector is decreased. However, this method deteriorates visibility of the projected image. Thus, in recent years, known as a technique for suppressing the deterioration in visibility or accuracy in image recognition is a projector system that exclusively controls imaging by a camera and projection by a projector.

Specifically, this projector system captures an image in a time zone different from a projection time by optimally adjusting any one or two or more of shutter speed, exposure, and gamma value of a camera. In other words, the projector system blocks projector light and obtains camera image data with an indicator clearly displayed by capturing an image within an imaging time different from a projection time. In this way, the projector system suppresses the deterioration in visibility and accuracy in image recognition.

Patent Document 1: Japanese Laid-open Patent Publication No. 2008-250482

Patent Document 2: International Publication Pamphlet No. WO 2006/085580

With the technique, however, it may be difficult to ensure operability. For example, with the projector system, even when an image of an indicator that operates a projected image is captured in a time zone different from a projection time, it may take time for processing for recognizing the indicator or details of the operation. In this case, a subsequent imaging time lags to coincide with the projection time, and accuracy in recognition of the captured image is deteriorated. Thus, operability is deteriorated as well.

### SUMMARY

According to an aspect of an embodiment, an input/output device includes a processor configured to switch an execution between a projection unit that projects projected images on a projection surface and an imaging unit that images the projection surface; and suppress projection of the projected images by the projection unit in a case where an indicator is included in captured images captured by the imaging unit, and execute projection by the projection unit in a case where an indicator is not included in captured images captured by the imaging unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view illustrating an overall configuration of a system according to a first embodiment of the present invention;

FIG. 2 is a functional block diagram illustrating a functional configuration of an input/output device according to the first embodiment;

FIG. 3 is a flowchart illustrating a flow of display control processing of the input/output device according to the first embodiment;

FIG. 4 is a flowchart illustrating a flow of operation control processing of the input/output device according to the first embodiment;

FIG. 5 is a diagram illustrating a conventional time chart;

FIG. 6 is a diagram illustrating a time chart in a display priority mode;

FIG. 7 is a view describing a projection surface during a display priority mode;

FIG. 8 is a diagram illustrating a time chart in an operation priority mode;

FIG. 9 is a view describing a projection surface during an operation priority mode;

FIG. 10 is a diagram describing an exemplary hardware configuration of the input/output device according to the first embodiment; and

FIG. 11 is a diagram describing an exemplary hardware configuration of an input/output device according to a second embodiment of the present invention.

### DESCRIPTION OF EMBODIMENTS

Preferred embodiments of the present invention will be explained with reference to accompanying drawings. This invention is not limited by this embodiment.

### [a] First Embodiment

Overall Configuration

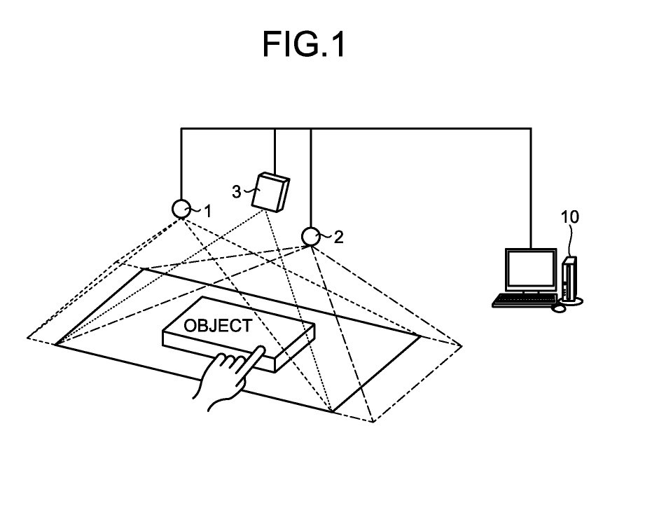

FIG. 1 is a view illustrating an overall configuration of a system according to a first embodiment of the present invention. As illustrated in FIG. 1, this system is an exemplary projector system including cameras 1 and 2, a projector 3, and an input/output device 10.

Specifically, the projector 3 projects, for example, images stored in the input/output device 10 on a projection surface. The cameras 1 and 2 capture the projection surface projected by the projector 3. The input/output device 10 detects a position of an indicator such as a hand from captured images captured by the two cameras, calculates a distance to the indicator by using disparity between the two cameras, and detects a tapping operation on an object.

Under these circumstances, the input/output device 10 switches execution between the projector 3 that projects a projected image on the projection surface and the cameras 1 and 2 that image the projection surface. In a case where a finger is included in the captured images captured by the cameras 1 and 2, the input/output device 10 suppresses projection of a projected image by the projector 3. In a case where a finger is not included in the captured images captured by the cameras 1 and 2, the input/output device 10 allows projection by the projector 3 while stopping imaging the projection surface by the cameras 1 and 2.

In other words, the input/output device 10 appropriately switches between a display priority mode and an operation priority mode. For example, in a case where an indicator such as a finger is not included in the images of the projection surface captured by the cameras 1 and 2, the input/output device 10 changes to the display priority mode in which projection by the projector 3 is prioritized. On the other hand, in a case where an indicator such as a finger is included in the images of the projection surface captured by the cameras 1 and 2, the input/output device 10 changes to the operation priority mode in which imaging by each camera is prioritized.

Thus, in operating an object to be projected, the input/output device 10 suppresses projection to prioritize imaging. Therefore, deterioration in accuracy in captured image recognition can be suppressed and operability can be secured.

Functional Configuration

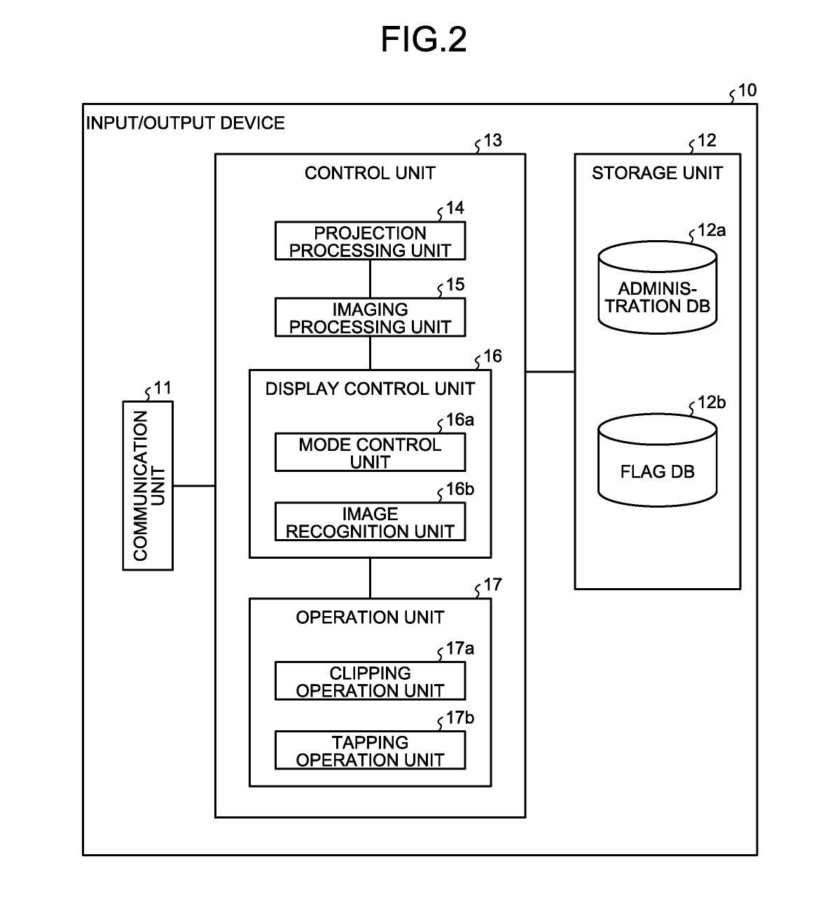

FIG. 2 is a functional block diagram illustrating a functional configuration of the input/output device according to the first embodiment. As illustrated in FIG. 2, the input/output device 10 includes a communication unit 11, a storage unit 12, and a control unit 13.

The communication unit 11 is a processing unit that controls communication of other devices by using wired or wireless communication, and is, for example, a communication interface. For example, the communication unit 11 transmits, for example, an imaging start or stop instruction to the cameras 1 and 2 and receives the images captured by the cameras 1 and 2. The communication unit 11 also transmits, for example, a projection start or suppression instruction to the projector 3.

The storage unit 12 is a storage device that stores programs executed by the control unit 13 and various types of data, and is, for example, a memory or a hard disk. This storage unit 12 stores an administration DB 12a and a flag DB 12b.

The administration DB 12a is a database that stores, for example, images captured by each camera. For example, the administration DB 12a stores, for example, data, size information, position information, and display condition on an area selected during a clipping operation for the projected image. The administration DB 12a also stores analysis results including position information of a finger identified through image recognition, details of the tapping operation, and the like.

The flag DB 12b is a database that stores flag information which identifies a current operation mode. For example, the flag DB 12b stores, for example, “off, on” as a “display priority flag, operation priority flag”. Information stored here is updated by processing units executed in the control unit 13.

The control unit 13 is a processing unit that controls the entire input/output device 10, and is an electronic circuit such as a processor. This control unit 13 includes a projection processing unit 14, an imaging processing unit 15, a display control unit 16, and an operation unit 17. The projection processing unit 14, the imaging processing unit 15, the display control unit 16, and the operation unit 17 exemplify an electronic circuit or a process executed by a processor.

The projection processing unit 14 is a processing unit that executes projection control for the projector 3. For example, the projection processing unit 14 transmits, for example, a projection start or stop instruction to the projector 3. The projection processing unit 14 also controls an illumination intensity of the projector 3 in projecting.

The imaging processing unit 15 is a processing unit that executes imaging control for the cameras 1 and 2. For example, the imaging processing unit 15 transmits, for example, an imaging start instruction to each camera and imports captured images captured by each camera. Then, the imaging processing unit 15 houses the imported captured images in the administration DB 12a.

The display control unit 16 includes a mode control unit 16a and an image recognition unit 16b, and is a processing unit that executes, by these units, processing and image recognition corresponding to each mode.

The mode control unit 16a is a processing unit that executes processing appropriate to an active mode. Specifically, the mode control unit 16a determines whether a current operation mode is a display priority mode or an operation priority mode with reference to the flag DB 12b, and executes processing appropriate to the determined operation mode.

For example, in a case where the current operation mode is the display priority mode, the mode control unit 16a outputs to the imaging processing unit 15 an instruction to inhibit imaging during projection from the projector 3. Once projection from the projector 3 stops, the mode control unit 16a outputs instruction of removal of imaging inhibition to the imaging processing unit 15.

As a result, the imaging processing unit 15 can inhibit imaging by each camera during projection from the projector 3. In the display priority mode, the imaging processing unit 15 may suppress imaging by each camera, and can suppress only importing images used for analyses after imaging by each camera is executed.

In a case where the current operation mode is the operation priority mode, the mode control unit 16a outputs to the projection processing unit 14 an instruction to inhibit projection from the projector 3 until imaging by each camera is finished. Then, once imaging is finished, the mode control unit 16a outputs to the projection processing unit 14 instruction of removal of projection inhibition. As a result, the projection processing unit 14 can inhibit projection from the projector 3 during imaging by each camera.

During the operation priority mode, the projection processing unit 14 can prioritize operation by making the illumination intensity of all projected images dimmer than during the display priority mode. Of the projected images, the projection processing unit 14 can make the illumination intensity of the projected images overlapping a finger, that is, the projected images subjected to the tapping operation, dimmer than during the display priority mode and make the illumination intensity of other projected images at the same level as during the display priority mode.

The image recognition unit 16b is a processing unit that recognizes a finger by analyzing the images captured by each camera. The image recognition unit 16b houses information on the recognized finger in the administration DB 12a. For example, the image recognition unit 16b extracts a position coordinate indicating a finger position, a trace of finger position information, and the like. The image recognition unit 16b extracts the information by using various types of publicly known processing for image recognition.

The operation unit 17 includes a clipping operation unit 17a and a tapping operation unit 17b, and is a processing unit that executes, by these units, various types of operations on the object projected on the projection surface.

The clipping operation unit 17a is a processing unit that executes the clipping operation on the object. Specifically, the clipping operation unit 17a captures a predetermined area of the object selected with a finger by a user to save in the administration DB 12a. In this way, an arbitrary area of the projected object can be clipped and saved.

The tapping operation unit 17b is a processing unit that executes the tapping operation on the object, and that switches operation modes depending on whether a finger that operates the object is detected.

For example, in a case where a finger is detected by the image recognition unit 16b from the captured images captured by each camera, the tapping operation unit 17b determines whether the position of the detected finger is on the object with reference to the administration DB 12a, for example. Here, in a case where the position of the detected finger is not on the object, the tapping operation unit 17b maintains the display priority mode.

On the other hand, in a case where the position of the detected finger is on the object, the tapping operation unit 17b rewrites a flag in the flag DB 12b to change the operation mode from the display priority mode to the operation priority mode. Then, the tapping operation unit 17b executes the tapping operation such as moving and rescaling of the object.

To cite a case, the tapping operation unit 17b detects, from the images continuously captured from when a finger is detected till when the finger is not detected, the positions of the object and the finger that has tapped the object (coordinate) to house in the administration DB 12a as a starting position. Subsequently, the tapping operation unit 17b detects a position where the tapping is completed, that is, a position where contact between the finger and the object is finished to house in the administration DB 12a as a finishing position.

Then, the tapping operation unit 17b executes movement of the object by moving the tapped object from the starting position to the finishing position. The tapping operation unit 17b can execute, for example, enlargement and reduction of the object besides movement thereof, but a technique used for smartphones, for example, can be used. Therefore, a detailed description will be omitted here.

Flow of Processing

Next, each processing executed by the input/output device according to the first embodiment will be described. Here, display control processing and operation control processing related particularly to the present embodiment will be described. The display control processing and the operation control processing are executed in parallel in a different thread.

Display Control Processing

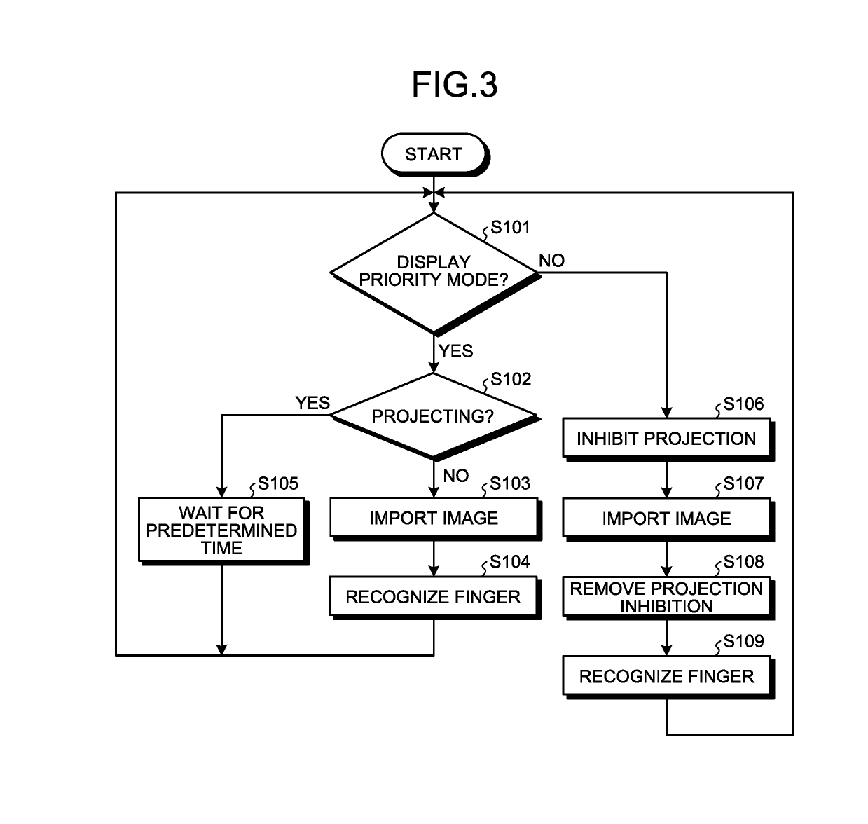

FIG. 3 is a flowchart illustrating a flow of display control processing of the input/output device according to the first embodiment. As illustrated in FIG. 3, if the mode control unit 16a determines that the operation mode is the display priority mode with reference to the flag DB 12b (S101: Yes), the mode control unit 16a determines whether the projector 3 is projecting via the projection processing unit 14 (S102).

If it is determined by the mode control unit 16a that the projector 3 is not projecting (S102: No), the imaging processing unit 15 imports images captured by each camera (S103). In other words, the imaging processing unit 15 captures images by using each camera and writes the captured images in the administration DB 12a. Subsequently, the image recognition unit 16b executes processing for image recognition of the imported captured images to recognize a finger and houses, for example, position information of the recognized finger in the administration DB 12a (S104). Then, returning to S101, processing thereafter is repeated.

On the other hand, if the mode control unit 16a determines that the projector 3 is projecting (S102: Yes), the mode control unit 16a repeats processing after S101 after waiting for a predetermined time (S105).

In S101, if the mode control unit 16a determines that the operation mode is the operation priority mode with reference to the flag DB 12b (S101: No), the mode control unit 16a transmits to the projection processing unit 14 an instruction to inhibit projection by the projector 3 (S106).

Subsequently, the imaging processing unit 15 imports the images captured by each camera (S107). Then, the mode control unit 16a transmits to the projection processing unit 14 an instruction to remove inhibition of projection by the projector 3 (S108). Subsequently, the image recognition unit 16b executes processing for image recognition of the imported images to recognize a finger and houses, for example, position information of the recognized finger in the administration DB 12a (S109). Then, returning to S101, processing thereafter is repeated.

Operation Control Processing

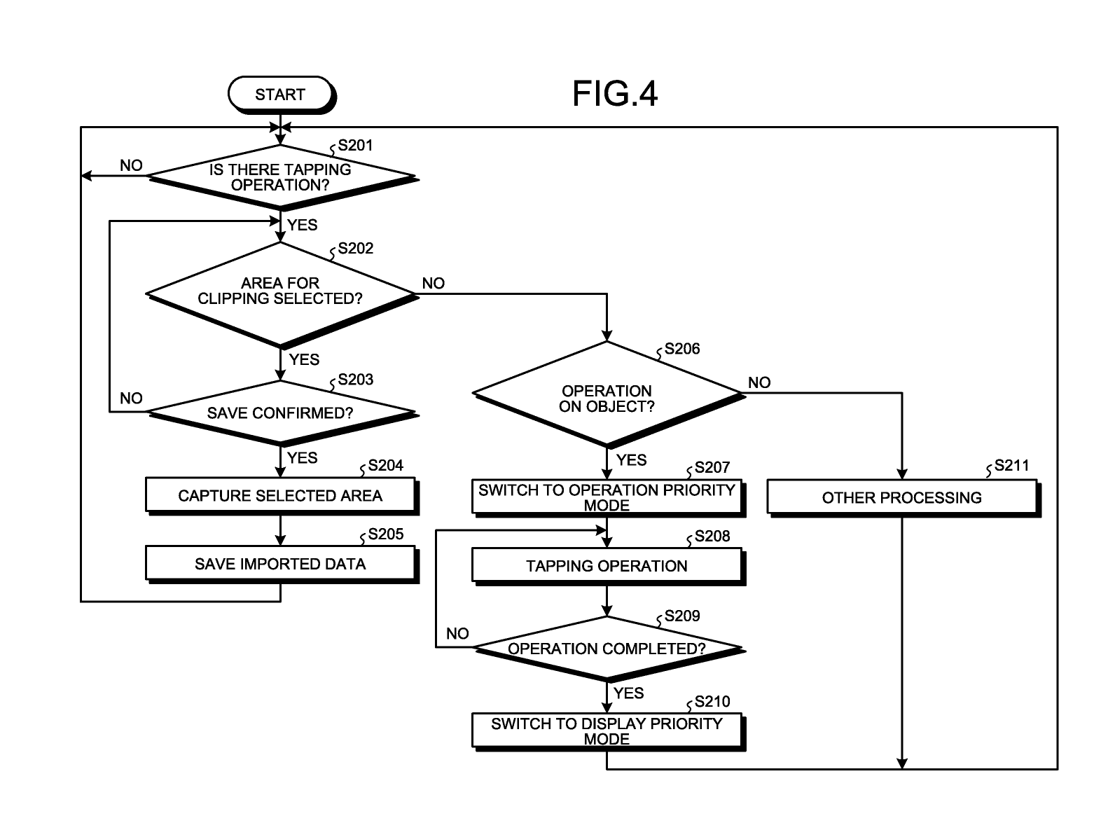

FIG. 4 is a flowchart illustrating a flow of operation control processing of the input/output device according to the first embodiment. As illustrated in FIG. 4, when the operation unit 17 detects a tapping operation (S201: Yes), the operation unit 17 determines whether an area for clipping is selected (S202). For example, if a finger is detected by the image recognition unit 16b, the operation unit 17 detects a tapping operation.

Then, if the clipping operation unit 17a detects the selection of the area for clipping (S202: Yes), the clipping operation unit 17a asks the user whether the selected area is to be saved (S203). For example, the clipping operation unit 17a checks for the user's intention to save by displaying, for example, a popup, or confirms the user's intention depending on whether a save button, for example, is pushed down.

Subsequently, if the clipping operation unit 17a saves the selected area (S203: Yes), the clipping operation unit 17a captures the selected area (S204) and imports the captured image to save in the administration DB 12a (S205). Then, returning to S201, processing thereafter is repeated. If the clipping operation unit 17a does not save the selected area (S203: No), the clipping operation unit 17a returns to S202 and repeats processing thereafter.

On the other hand, if the selection of the area for clipping is not detected (S202: No), the tapping operation unit 17b determines whether the operation is on the object (S206). For example, the tapping operation unit 17b determines whether the position of the finger detected by the image recognition unit 16b is on the object.

If the tapping operation unit 17b determines that the operation is on the object (S206: Yes), the tapping operation unit 17b rewrites the flag information in the flag DB 12b to switch to the operation priority mode (S207). Subsequently, the tapping operation unit 17b executes the tapping operation (S208).

Then, the tapping operation unit 17b repeats processing in S208 until the tapping operation is completed (S209: No). If the tapping operation is completed (S209: Yes), the tapping operation unit 17b rewrites the flag information in the flag DB 12b to switch to the display priority mode (S210). Then, returning to S201, processing thereafter is repeated.

In S206, if the tapping operation unit 17b determines that the operation is not on the object (S206: No), the tapping operation unit 17b executes other predetermined processing such as maintaining the display priority mode (S211). Then, returning to S201, processing thereafter is repeated.

Comparison of Processing

Next, each processing will be compared by using a time chart according to a conventional technique, a time chart during the display priority mode according to the present embodiment, and a time chart during the operation priority mode according to the present embodiment.

Conventional

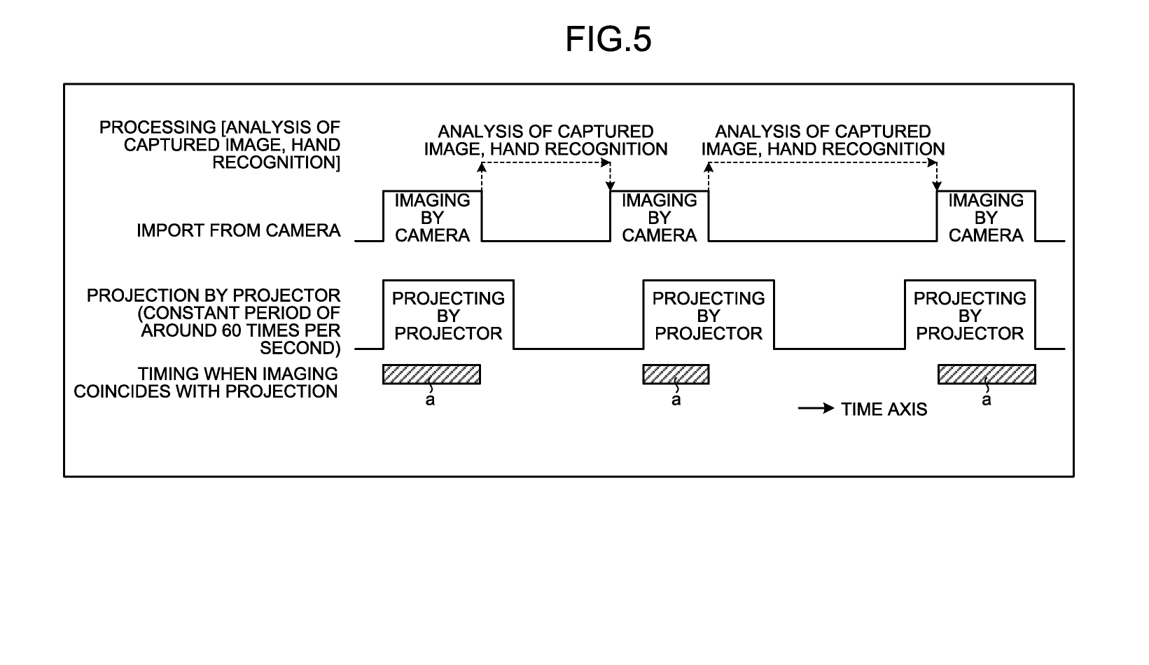

FIG. 5 is a diagram illustrating a conventional time chart. As illustrated in FIG. 5, the projector 3 projects images on the projection surface with a constant period of 60 times per second, for example. On the other hand, each camera is controlled to repeat imaging the projection surface, analyzing the captured images, and hand recognition. In other words, an imaging timing of each camera is after processing for analyses of the captured images and hand recognition is finished, and thus depends on each processing.

Accordingly, as illustrated by (a) in FIG. 5, the imaging timing of each camera may coincide with a period of projection by the projector. Then, each camera captures images including a hand with a projected image projected from the projector displayed on. Then, in processing for analyses of the captured images and hand recognition, an event, for example, where the hand is not properly recognized may occur, and an operation by hand is not properly executed in some cases.

It is also possible to capture an image in a time zone different from the projection time by optimally adjusting any one or two or more of shutter speed, exposure, and gamma value of a camera. However, in a case where the processor of the input/output device is a low-cost, low performance processor, it takes time for processing for analyses of the captured images and hand recognition. In a case where a delay is occurred in communication between the cameras and the input/output device, start of processing for analyses of the captured images and hand recognition is delayed.

In these cases, even when a time is divided between imaging and projection, the time for imaging gradually lags to coincide with that for projection, which leads to capturing images including a hand with a projected image displayed on. As a result, operability is deteriorated.

Display Priority Mode

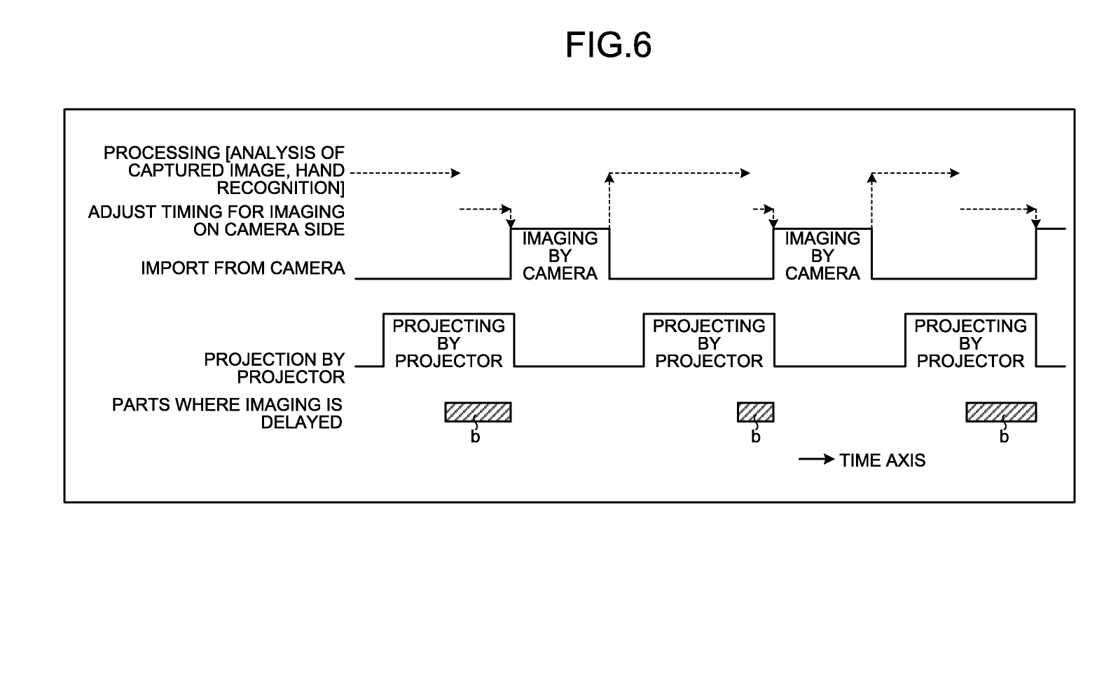

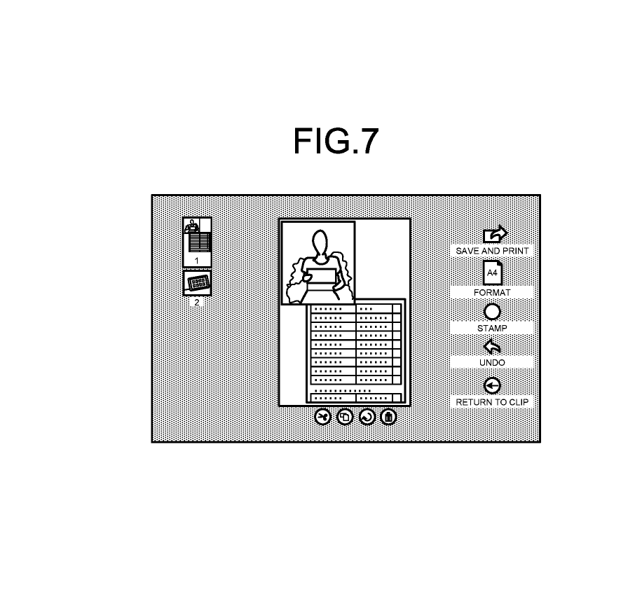

FIG. 6 is a diagram illustrating a time chart in the display priority mode. FIG. 7 is a view describing the projection surface during the display priority mode. In other words, FIG. 6 is a time chart executed when a finger is not included in the captured images captured by each camera.

In the display priority mode, as illustrated in FIG. 7, a finger is not detected on the projection surface. Thus, the projection processing unit 14 continues projection with priority on projection by the projector 3, while the imaging processing unit 15 suppresses imaging by each camera during projection by the projector 3.

Therefore, as illustrated in FIG. 6, the projector 3 projects images on the projection surface with a constant period of 60 times per second, for example. Each camera suppresses imaging the projection surface during projection by the projector 3, and captures the projection surface when projection by the projector 3 is not executed.

In other words, even at the imaging timing, in a case where projection by the projector 3 is being executed, the imaging processing unit 15 suppresses importing images by using each camera and imports images at a delayed timing. Therefore, as illustrated by (b) in FIG. 6, a delay in imaging is occurred. However, the time lag is negligible, and thus, it is possible to ensure both operability and visibility.

Operation Priority Mode

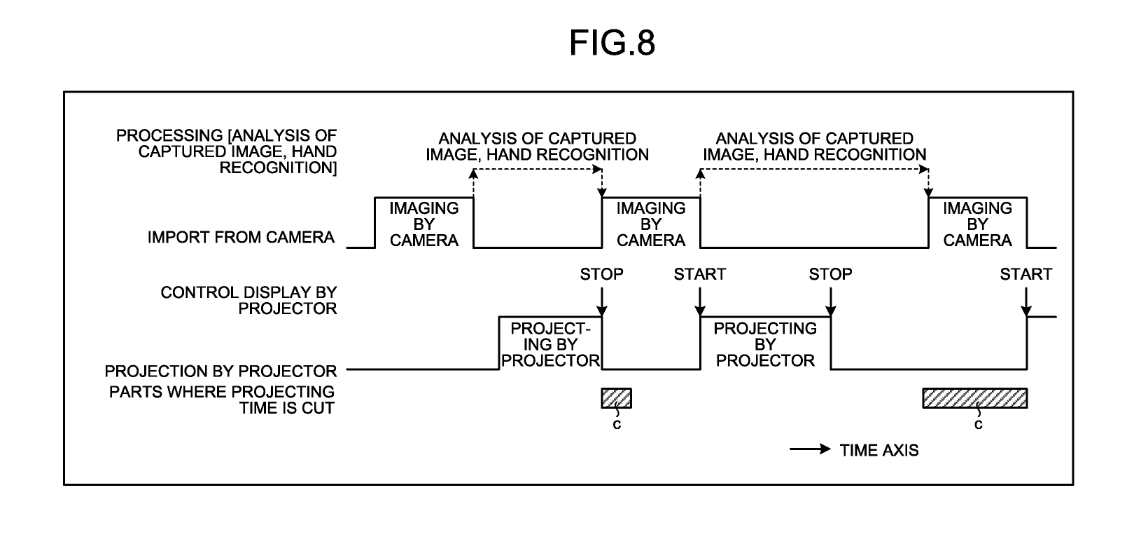

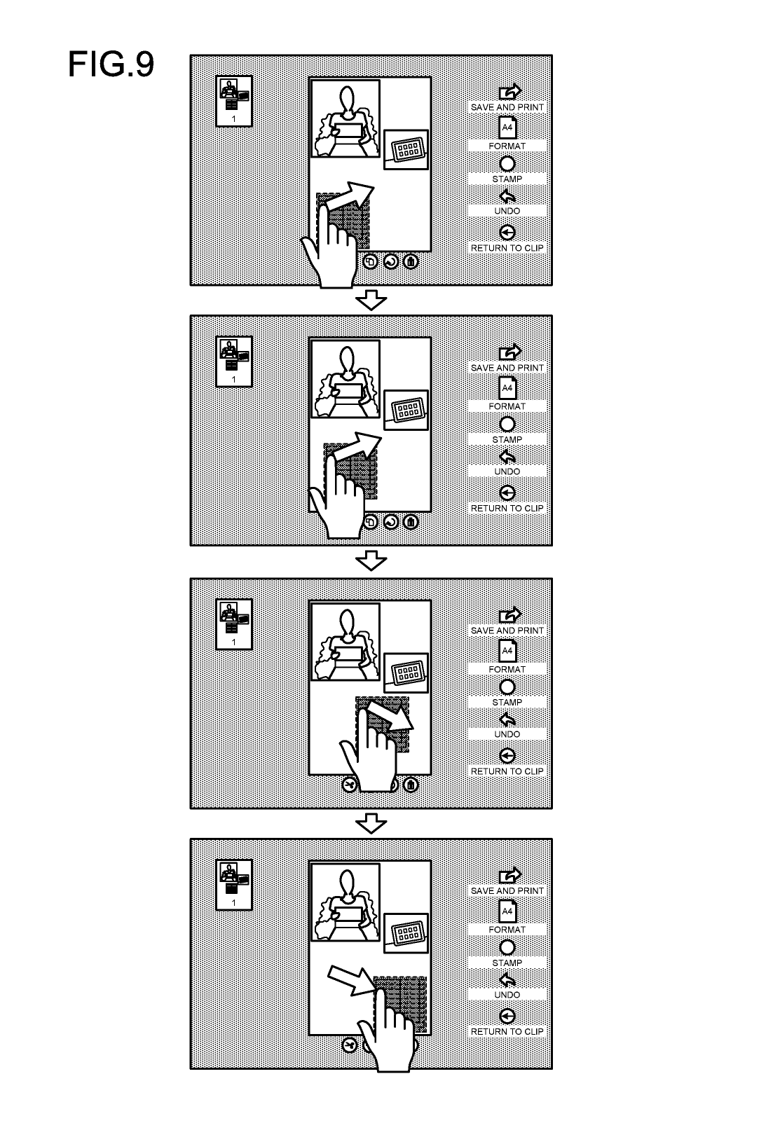

FIG. 8 is a diagram illustrating a time chart in the operation priority mode. FIG. 9 is a view describing the projection surface during the operation priority mode. In other words, FIG. 8 is a time chart executed when it is detected after the condition in FIG. 6 that a finger is included in the captured images captured by each camera.

In the operation priority mode, as illustrated in FIG. 9, a finger is detected on the projection surface. Thus, the imaging processing unit 15 executes imaging by each camera during projection by the projector 3, while the projection processing unit 14 suppresses projection by the projector 3.

Therefore, as illustrated in FIG. 8, imaging of the projection surface is executed by each camera at a predetermined timing for imaging, and analyses of the captured images and hand recognition are executed by the display control unit 16. Even if a constant period of 60 times per second, for example, is set, the projector 3 suppresses projection during imaging by each camera and projects when imaging by each camera is not executed.

In other words, as illustrated by (c) in FIG. 8, a delay in projection by the projector 3 is occurred. However, it is possible to properly capture and analyze a hand with a projected image not displayed on. Therefore, operability can be ensured.

Of the projected images, the projection processing unit 14 can dim only the illumination intensity of the projected images overlapping a finger, that is, the projected images subjected to the tapping operation. For example, as illustrated in FIG. 9, three images are projected. A description will be given in an example where one of those images is tapped with a finger.

In this case, the projection processing unit 14 identifies a tapped projected image and makes the illumination intensity of the identified projected image dimmer than a normal value based on coordinate of each projected image and coordinate indicating the finger position from the image recognition unit 16b and the administration DB 12a. By continuing referring to the image recognition unit 16b and the administration DB 12a, the projection processing unit 14 can follow the projected image in operation and the finger position by the tapping operation as illustrated in FIG. 9 and constantly make the illumination intensity of the projected image in operation dimmer than a normal value.

### Effects

As described above, in a case where a finger is detected on the projected surface of the projector 3, the input/output device 10 suppresses projection from the projector 3, prioritizes imaging of the projection surface by each camera, and preferentially executes finger recognition. In a case where a finger is not detected on the projection surface of the projector 3, the input/output device 10 suppresses imaging by each camera and preferentially executes projection from the projector 3.

Thus, by operating while switching two operation modes, the input/output device 10 can keep finger recognition highly accurate while maintaining visibility. Even in a case where a low performance processor is mounted, the input/output device 10 can satisfy both visibility and operability. Similarly, even if a communication line with each camera is low in performance, the input/output device 10 can minimize other causes for delays. Therefore, both visibility and operability can be satisfied.

### [b] Second Embodiment

An embodiment according to the present invention has been described above. However, the present invention may be implemented in other various different forms than the embodiment described above.

Operation Priority Mode

For example, an example has been described where the input/output device 10 suppresses projection from the projector 3 while imaging of the projection surface is executed, in operating in the operation priority mode, but the input/output device 10 is not limited to this example. For example, the input/output device 10 can also suppress projection from the projector 3 until recognition of the finger position from the captured images on the projection surface is finished.

This allows the input/output device 10 to accurately recognize, for example, the finger position. The input/output device 10 can suppress projection from the projector 3 for a certain period of time. Therefore, in following the tapping operation of the finger, it is possible to switch between projection and imaging less frequent and maintain a high level of visibility.

System

Each configuration of illustrated devices does not always need to be physically configured as illustrated. In other words, a configuration is possible by decentralization or integration by the arbitrary unit. Furthermore, in terms of each processing function executed at each device, all or an arbitrary part thereof can be realized by a CPU and a program analyzed and executed on the CPU, or can be realized as a hardware by wired logic.

Of each processing described in the present embodiment, all or a part thereof described as that which is automatically executed can be executed manually, or all or a part thereof described as that which is executed manually can be automatically executed by a publicly known method. Besides, processing procedures, controlling procedures, specific names, and information including various types of data and parameters illustrated in the text and drawings can be arbitrarily changed unless otherwise specified.

Hardware

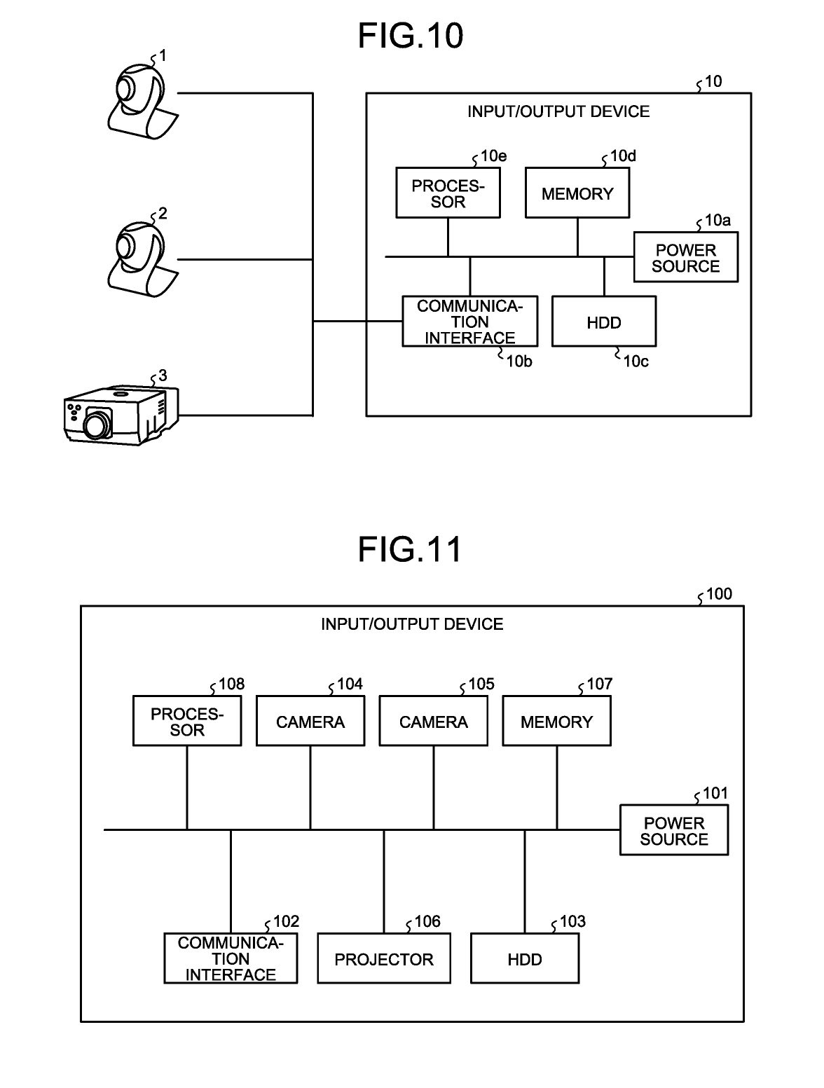

FIG. 10 is a diagram describing an exemplary hardware configuration of the input/output device according to the first embodiment. As illustrated in FIG. 10, the input/output device 10 includes a power source 10a, a communication interface 10b, a Hard Disk Drive (HDD) 10c, a memory 10d, and a processor 10e. Each unit illustrated in FIG. 10 is connected to one another by a bus, for example.

The power source 10a obtains power supplied from outside to operate each unit. The communication interface 10b is an interface that controls communication with other devices and is, for example, a network interface card. The HDD 10c stores programs that operate functions illustrated in, for example, FIG. 2, DBs, and tables.

The processor 10e operates a process that executes each function described in, for example, FIG. 2 by reading programs that execute processing similar to each processing unit illustrated in, for example, FIG. 2 from the HDD 10c, for example, to load into the memory 10d.

In other words, this process executes functions similar to each processing unit included in the input/output device 10. Specifically, the processor 10e reads from, for example, the HDD 10c programs with functions similar to the projection processing unit 14, the imaging processing unit 15, the display control unit 16, the operation unit 17, and the like. Then, the processor 10e executes a process that executes processing similar to the projection processing unit 14, the imaging processing unit 15, the display control unit 16, and the operation unit 17.

In this way, the input/output device 10 operates as an information processing device that executes an input/output method by reading and executing programs. The input/output device 10 can also realize functions similar to the embodiment described above by reading the programs from a recording medium by a medium reading device and executing the read programs. Programs in other embodiments are not limited to being executed by the input/output device 10. For example, the present invention can similarly be applied in a case where other computers or servers execute programs or in a case where they cooperate to execute the programs.

Housing

In the first embodiment, an example has been described where each camera, the projector 3, and the input/output device 10 are realized in separate housings, but they are not limited to this example and can be realized in an identical housing.

FIG. 11 is a diagram describing an exemplary hardware configuration of an input/output device according to a second embodiment of the present invention. As illustrated in FIG. 11, an input/output device 100 includes a power source 101, a communication interface 102, an HDD 103, cameras 104 and 105, a projector 106, a memory 107, and a processor 108. Each unit illustrated in FIG. 11 is connected to one another by a bus, for example.

The power source 101 obtains power supplied from outside to operate each unit. The communication interface 102 is an interface that controls communication with other devices and is, for example, a network interface card. The HDD 103 stores programs that operate functions illustrated in, for example, FIG. 2, DBs, and tables.

The cameras 104 and 105 execute functions similar to the cameras 1 and 2 illustrated in FIG. 1, respectively, and the projector 106 executes functions similar to the projector 3 illustrated therein.

As with FIG. 10, the processor 108 operates a process that executes each function described in, for example, FIG. 2 by reading programs that execute processing similar to each processing unit illustrated in, for example, FIG. 2 from the HDD 103, for example, to load into the memory 107.

In this way, the input/output device 100 operates as an information processing device that executes an input/output method by reading and executing programs. The input/output device 100 can also realize functions similar to the embodiment described above by reading the programs from a recording medium by a medium reading device and executing the read programs. Programs in other embodiments are not limited to being executed by the input/output device 100. For example, the present invention can similarly be applied in a case where other computers or servers execute programs or in a case where they cooperate to execute the programs.

According to the embodiment of the present invention, operability can be secured.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An input/output device comprising:
a processor configured to:
switch an execution between a projection unit that projects projected images on a projection surface and an imaging unit that images the projection surface; and
suppress projection of the projected images by the projection unit in a case where an indicator is included in captured images captured by the imaging unit, and execute projection by the projection unit in a case where an indicator is not included in captured images captured by the imaging unit.

2. The input/output device according to claim 1, wherein the processor is further configured to:
suppress projection of the projected image by the projection unit, in a case where an indicator is included in captured images captured by the imaging unit, until processing for detecting a position instructed by the indicator is finished.

3. The input/output device according to claim 1, wherein the processor is further configured to:
in a case where an indicator is included in captured images captured by the imaging unit, among the projected images, allow projected images that include the indicator to be projected at illumination intensity dimmer than the projected images that does not include the indicator.

4. An input/output method comprising:
switching an execution between a projection unit that projects projected images on a projection surface and an imaging unit that captures the projection surface, using a processor; and
suppressing projection of the projected images by the projection unit in a case where an indicator is included in captured images captured by the imaging unit, and allowing projection by the projection unit in a case where an indicator is not included in captured images captured by the imaging unit, using the processor.

5. A non-transitory computer-readable recording medium having stored therein an input/output program that causes a computer to execute a process comprising:
switching an execution between a projection unit that projects projected images on a projection surface and an imaging unit that captures the projection surface; and
suppressing projection of the projected images by the projection unit in a case where an indicator is included in captured images captured by the imaging unit, and allowing projection by the projection unit in a case where an indicator is not included in captured images captured by the imaging unit.
